(19) United States
(12) Patent Application Publication
(10) Pub. No.: US 2024/0201323 A1
(43) Pub. Date: Jun. 20, 2024

(54) VEHICLE RADAR DEVICE

(71) Applicant: DENSO CORPORATION, Kariya-city (JP)

(72) Inventors: Yasuhiro KURONO, Kariya-city (JP); Yutaka HASEGAWA, Kariya-city (JP); Takuya TAKAYAMA, Kariya-city (JP)

(21) Appl. No.: 18/590,672

(22) Filed: Feb. 28, 2024

Related U.S. Application Data
(63) Continuation of application No. PCT/JP2022/032858, filed on Aug. 31, 2022.

(30) Foreign Application Priority Data
Aug. 31, 2021 (JP) 2021-141578

(51) Int. Cl. G01S 7/35; G01S 13/42; G01S 13/58; G01S 13/931

(52) U.S. Cl. CPC G01S 7/354; G01S 13/42; G01S 13/584; G01S 13/931

(57) ABSTRACT

A vehicle radar apparatus detects a position and a velocity of a target object. The radar apparatus selects, as a relay reflection target object, a moving body capable of relaying transmission and reception of the radar wave to and from another target object, from target objects detected. The radar apparatus sets a multipath ghost condition indicating the position and the velocity of the target object erroneously detected as a result of a stationary object to which the radar wave is relayed by the relay reflection target object, based on the position and the velocity of the relay reflection target object and the velocity of an own vehicle. The radar apparatus extracts a target object that meets the multipath ghost condition from the detected target objects, determines that the extracted target object is a multipath ghost, and restricts output of a detection result from the radar apparatus to an external apparatus.

### CROSS-REFERENCE TO RELATED APPLICATION

The present application is a continuation application of International Application No. PCT/JP2022/032858, filed on Aug. 31, 2022, which claims priority to Japanese Patent Application No. 2021-141578, filed on Aug. 31, 2021. The contents of these applications are incorporated herein by reference in their entirety.

### BACKGROUND

### Technical Field

The present disclosure relates to a vehicle radar apparatus that detects a target object in a vicinity of an own vehicle by transmitting and receiving radar waves.

### Related Art

In the vehicle radar apparatus, when a target object is detected through transmission and reception of radar waves, a reflected wave reflected by the target object may return after striking another target object. When multipath such as this occurs, a target object (hereafter, a multipath ghost) is erroneously detected as being present in a position in which the target object is not actually present.

### SUMMARY

One aspect of the present disclosure provides a vehicle radar apparatus that is mounted to a vehicle and detects a target object in a vicinity of an own vehicle. The radar apparatus detects a position and a velocity of the target object by transmitting a radar wave to the vicinity of the own vehicle, receiving a reflected wave of the radar wave, and performing frequency analysis on transmission and reception signals. The radar apparatus selects, as a relay reflection target object, a moving body that is capable of relaying transmission and reception of the radar wave to and from another target object, from a plurality of target objects detected by the radar apparatus. The radar apparatus sets a multipath ghost condition that indicates the position and the velocity of the target object erroneously detected by the radar apparatus as a result of a stationary object to which the radar wave is relayed by the relay reflection target object, based on the position and the velocity of the relay reflection target object and the velocity of the own vehicle. The radar apparatus extracts a target object that meets the multipath ghost condition from the plurality of target objects detected by the radar apparatus, determines that the extracted target object is a multipath ghost, and restricts output of a detection result from the radar apparatus to an external apparatus

### BRIEF DESCRIPTION OF THE DRAWINGS

In the accompanying drawings:

FIG. 1 is a block diagram of a configuration of a radar apparatus according to an embodiment;

FIG. 2 is an explanatory diagram of an arrangement of the radar apparatus in a vehicle and a multipath ghost generated by a stationary object;

FIG. 3 is a block diagram of a functional configuration of a processing unit;

FIG. 4 is a flowchart of a multipath ghost determination process performed by the processing unit; and

FIG. 5 is a flowchart of a multipath ghost determination process according to another embodiment.

### DESCRIPTION OF THE EMBODIMENTS

JP 2020-197506 A describes that whether a detected target object is a multipath ghost is determined. In a vehicle radar apparatus described in JP 2020-197506 A, when a first object is detected, whether a reflection point reflecting a radar wave reflected by the first object is present in the vehicle vicinity is determined. Then, when the reflection point is present, if a second object is detected following the first object, whether the second object is a multipath ghost is determined based on relative velocities between the first object, the reflection point, and the second object, and the own vehicle.

In the vehicle radar apparatus described in JP 2020-197506 A, a sign, a wall surface of a tunnel, a vehicle having a higher vehicle height than the own vehicle, and the like in the own vehicle vicinity are detected as the reflection point based on position information of the own vehicle, map information, image information on the own vehicle vicinity, and the like.

Therefore, even in cases in which a multipath ghost is generated by a stationary object in the vehicle vicinity, whether a reflection point is present is required to be determined using the map information and the like. A problem occurs in that time is required for the determination of the multipath ghost.

It is thus desired to enable, in a vehicle radar apparatus, a detected target object to be determined to be a multipath ghost generated by a stationary object, without detection of a reflection point that causes the multipath ghost.

A first exemplary embodiment of the present disclosure provides a vehicle radar apparatus that is mounted to a vehicle and detects a target object in a vicinity of an own vehicle, the radar apparatus including a target object detecting unit, a relay reflection target object selecting unit, a multipath ghost condition setting unit, and a multipath ghost determining unit.

The target detecting unit detects a position and a velocity of the target object by transmitting a radar wave to the vicinity of the own vehicle, receiving a reflected wave of the radar wave, and performing frequency analysis on transmission and reception signals. The relay reflection target object selecting unit selects, as a relay reflection target object, a moving body that is capable of relaying transmission and reception of the radar wave to and from another target object, from a plurality of target objects detected by the target object detecting unit.

The multipath ghost condition setting unit sets a multipath ghost condition that indicates the position and the velocity of the target object erroneously detected by the target object detecting unit as a result of a stationary object to which the radar wave is relayed by the relay reflection target object, based on the position and the velocity of the relay reflection target object and the velocity of the own vehicle.

The multipath ghost determining unit extract a target object that meets the multipath ghost condition from the plurality of target objects detected by the target object detecting unit, determines that the extracted target object is a multipath ghost, and restrict output of a detection result from the target object detecting unit to an external apparatus

Therefore, as a result of the vehicle radar apparatus of the exemplary embodiment of the present disclosure, whether a target object detected by the target object detecting unit is a multipath ghost generated by a stationary object can be determined without a reflection point that causes the multipath ghost being identified, and a relative velocity between the reflection point and the own vehicle being detected.

Therefore, as a result of the vehicle radar apparatus of the exemplary embodiment of the present disclosure, the determination of the multipath ghost can be performed by a simpler determination operation than that of the apparatus described in JP 2020-197506 A. Consequently, the determination of the multipath ghost can be appropriately performed even during high-speed travel of the vehicle in which the determination of the multipath ghost is required to be performed in a short amount of time.

In addition, when determined that the target object detected by the target object detecting unit is a multipath ghost, the multipath ghost determining unit restricts output of the detection result of the target object to the external apparatus. Therefore, the external apparatus can be suppressed from performing an erroneous operation due to the multipath ghost. For example, when the external apparatus is an apparatus that performs traveling assistance of the own vehicle, unnecessary steering can be suppressed from being performed to avoid the multipath ghost that is not actually present.

Furthermore, the vehicle radar apparatus of the present disclosure is configured to determine the multipath ghost generated as a result of a stationary object, in particular. Therefore, the target object is suppressed from being erroneously determined to be a multipath ghost generated by a moving body. Consequently, as a result of the vehicle radar apparatus of the present disclosure, decrease in detection accuracy regarding a moving body that is necessary for traveling assistance of the own vehicle can be suppressed, and traveling assistance of the own vehicle by the external apparatus can be favorably performed.

A second exemplary embodiment of the present disclosure provides a vehicle radar apparatus that is mounted to a vehicle and detects a target object in a vicinity of an own vehicle, the vehicle radar apparatus comprising: a processor; a non-transitory computer-readable storage medium; and a set of computer-executable instructions stored in the computer-readable storage medium that, when read and executed by the processor, to implement: detecting a position and a velocity of the target object by transmitting a radar wave to the vicinity of the own vehicle, receiving a reflected wave of the radar wave, and performing frequency analysis on transmission and reception signals; selecting, as a relay reflection target object, a moving body that is capable of relaying transmission and reception of the radar wave to and from another target object, from a plurality of target objects detected; setting a multipath ghost condition that indicates the position and the velocity of the target object erroneously detected as a result of a stationary object to which the radar wave is relayed by the relay reflection target object, based on the position and the velocity of the relay reflection target object and a velocity of the own vehicle; and extracting a target object that meets the multipath ghost condition from the plurality of target objects detected, determine that the extracted target object is a multipath ghost, and restrict output of a detection result from the target object detecting unit to an external apparatus.

An embodiment of the present disclosure will hereinafter be described with reference to the drawings.

### Configuration

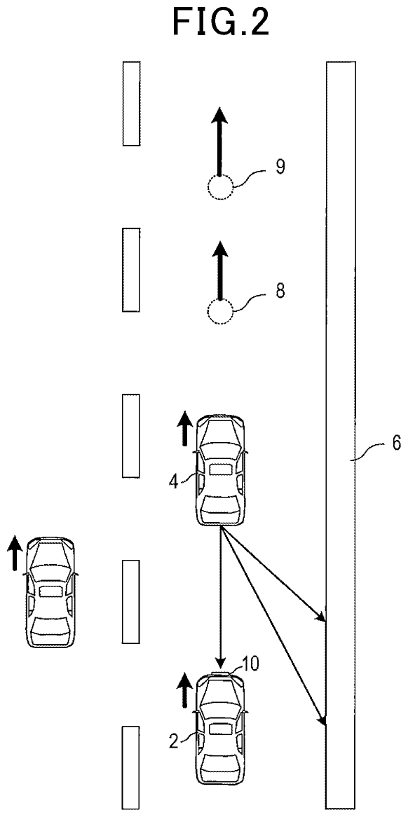

As shown in an example in FIG. 2, a radar apparatus 10 according to the present embodiment is a vehicle radar apparatus that is arranged in a front center portion of a vehicle 2, such as on a back side of a front bumper.

The radar apparatus 10 is used to detect a target object such as another vehicle 4 that is present ahead of the vehicle (hereafter, an own vehicle) 2 in which the radar apparatus 10 is mounted by radiating radar waves ahead of the own vehicle 2 and receiving reflected waves of the radar waves.

Here, according to the present embodiment, the radar apparatus 10 is described as that which detects a target object that is ahead of the own vehicle 2. However, the radar apparatus 10 may be attached to the own vehicle 2 so as to detect a target object that is present to the rear, the left side, or the right side of the own vehicle 2.

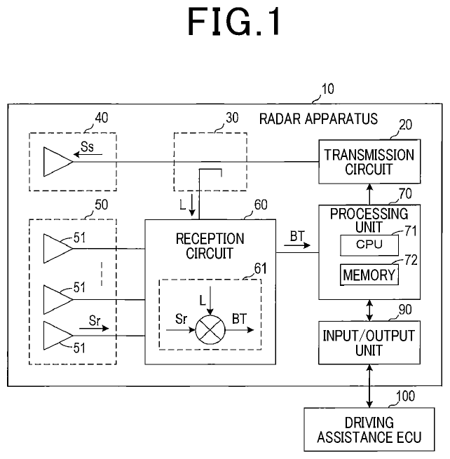

As shown in FIG. 1, the radar apparatus 10 includes a transmission circuit 20, a distributor 30, a transmission antenna 40, a reception antenna 50, a reception circuit 60, a processing unit 70, and an input/output unit 90.

The transmission circuit 20 is a circuit for supplying a transmission signal Ss to the transmission antenna 40. The transmission circuit 20 inputs a millimeter-band, high-frequency signal to the distributor 30 that is positioned upstream of the transmission antenna 40.

For example, the transmission circuit 20 performs modulation such that the frequency of the high-frequency signal gradually increases from a lowest start frequency to a highest end frequency. By repeating the modulation in steps, the transmission circuit 20 generates a high-frequency signal that has been modulated by folded chirp waveform (FCW) and inputs the high-frequency signal to the distributor 30. Therefore, the radar apparatus 10 according to the present embodiment is a first chirp modulation (FCM)-type radar apparatus.

However, for example, the radar apparatus 10 may be a frequency-modulated continuous wave (FM-CW)-type radar apparatus in which the transmission circuit 20 periodically gradually increases and gradually decreases the frequency of the high-frequency signal. In addition, for example, the radar apparatus 10 may be a dual-frequency CW-type radar apparatus in which the transmission circuit 20 periodically switches the frequency of the high-frequency signal between two values.

The distributor 30 distributes power of the high-frequency signal inputted from the transmission circuit 20 to the transmission signal Ss and a local signal L. Based on the transmission signal Ss supplied from the distributor 30, the transmission antenna 40 radiates a radar wave of a frequency corresponding to the transmission signal Ss.

The reception antenna 50 is an antenna for receiving a reflected wave that is a radar wave reflected by a target object. The reception antenna 50 is configured as a linear array antenna in which a plurality of antenna elements 51 are arranged in a single row. A reception signal Sr of the reflected wave from each antenna element 51 is inputted to the reception circuit 60.

The reception circuit 60 processes the reception signal Sr inputted from each antenna element 51 configuring the reception antenna 50, and generates and outputs a beat signal BT for each antenna element 51. Specifically, the reception circuit 60 generates and outputs the beat signal BT for each antenna element 51 by using a mixer 61 to mix the reception signal Sr inputted from the antenna element 51 and the local signal L inputted from the distributor 30 for each antenna element 51.

However, a process up to the output of the beat signal BT includes a process in which the reception signal Sr is amplified and a process in which unnecessary signal components are removed from the beat signal BT.

In this manner, the beat signal BT for each antenna element 51 that is generated and outputted by the reception circuit 60 is inputted to the processing unit 70.

The processing unit 70 includes a microcomputer that has a central processing unit (CPU) 71 and a semiconductor memory (hereafter, a memory 72), such as a random access memory (RAM) or a read-only memory (ROM). In addition, the processing unit 70 may include a coprocessor that performs a fast Fourier transform (hereafter, FFT) process and the like.

The processing unit 70 periodically repeatedly performs a detection operation (hereafter, a target object detection process) in which a distance R to the target object, a velocity V of the target object, and an azimuth θ of the target object are calculated for each target object reflecting the radar wave, through frequency analysis of the beat signal BT for each antenna element 51.

The velocity V of the target object is a relative velocity in relation to the own vehicle 2 and is substantially “−1×velocity” when the target object reflecting the radar wave is a stationary object. In addition, the azimuth θ of the target object is calculated with a radiation direction center axis of the radar wave from the radar apparatus 10 as 0 degrees.

A detection result for the target object by the processing unit 70 is outputted from the input/output unit 90 to a driving assistance ECU 100 of the own vehicle 2. In addition, the input/output unit 90 is also used when the processing unit 70 acquires a driving state of the own vehicle 2, such as a velocity and a steering angle of the own vehicle 2, from an external apparatus such as the driving assistance ECU 100.

ECU is an abbreviation of Electronic Control Unit. The driving assistance ECU 100 performs various types of processes to assist driving of the own vehicle 2 by a driver, based on the detection result for the target object inputted from the radar apparatus 10.

The processes related to driving assistance may include, for example, a process for issuing a warning to the driver that an approaching object is present, and a process for controlling a brake apparatus and a steering apparatus of the own vehicle 2 to avoid a collision with the approaching object. In addition, a process for controlling a drive system, a braking system, and an operating system of the own vehicle 2 to make the own vehicle 2 follow a leading vehicle may also be included.

### [Functions of the Processing Unit 70]

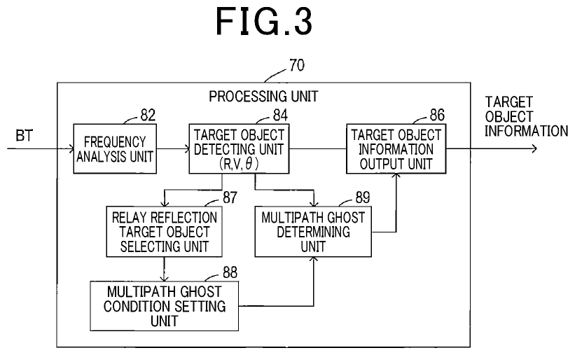

Next, as shown in FIG. 3, as a functional configuration, the processing unit 70 includes a frequency analysis unit 82, a target object detecting unit 84, a target object information output unit 86, a relay reflection target object selecting unit 87, a multipath ghost condition setting unit 88, and a multipath ghost determining unit 89.

The frequency analysis unit 82 provides a function for searching a target object that is present in the radiation direction of the radar wave by performing analog-to-digital (A/D) conversion on the beat signal BT to receive digital data of the beat signal BT, and performing fast Fourier transform (hereafter, FFT) on the received digital data of the beat signal BT.

Specifically, the frequency analysis unit 82 analyzes a distance frequency by, for example, performing the FFT process on the beat signal BT for each chirp of the transmission signal of which the frequency is gradually increased from the start frequency to the end frequency by FCM modulation. In addition, the frequency analysis unit 82 analyzes a velocity frequency by performing the FFT process on the distance frequency in a chirp direction.

As a result, through such a two-dimensional FFT process, the frequency analysis unit 82 acquires an analysis result in which a peak of a power spectrum is generated in a coordinate system for distance and velocity. Then, from the analysis result, the target object detecting unit 84 identifies a target object that is present in the radiation direction of the radar wave and determines the distance R to the target object and the velocity V of the target object.

In addition, the frequency analysis unit 82 determines the azimuth θ of each target object from a phase difference in the beat signal BT acquired from each antenna element 51. The target object detecting unit 84 identifies a position of each target object from the distance R and the azimuth θ determined for each target object, and outputs the position to the target object information output unit 86 together with the velocity V of the target object. Here, the two-dimensional FFT and azimuth detection based on phase difference in the radar apparatus are known technology. Therefore, details thereof are omitted herein.

The target object information output unit 86 outputs target object information indicating the distance R, the azimuth θ, and the velocity V of each target object outputted from the target object detecting unit 84 to the driving assistance ECU 100. In addition, the target object information output unit 84 restricts the output of target object information regarding a target object that is determined to be a multipath ghost, based on a command from the multipath ghost determining unit 89.

Here, the restriction is performed by the output of target object information being stopped or target object information to which information indicating that the target object is a multipath ghost is added being outputted. As a result, the driving assistance ECU 100 can be suppressed from erroneously performing driving assistance, such as evacuation traveling, under an assumption that the multipath ghost is a target object that is actually present.

Next, the relay reflection target object selecting unit 87, the multipath ghost condition setting unit 88, and the multipath ghost determining unit 89 are for determining whether the target object detected by the target object detecting unit 84 is a multipath ghost generated by a stationary object.

As shown as an example in FIG. 2, a multipath ghost 8 generated by a stationary object is erroneously detected as a result of a radar wave being incident on and reflected by another vehicle 4 that is traveling ahead of the own vehicle 2, and a portion of the reflected wave striking a stationary object 6, such as a guardrail, and returning to the own vehicle 2 via the other vehicle 4.

In this case, the other vehicle 4 traveling ahead of the own vehicle 2 is a relay reflection target object that relays the radar wave that is transmitted and received between the own vehicle 2 and the stationary object 6. In addition, the multipath ghost 8 is erroneously detected as a target object that is present farther than the relay reflection target object as a result of a path length of the radar wave that travels via the relay reflection target object.

Therefore, the relay reflection target object selecting unit 87 selects, as the relay reflection target object, a moving body such as the other vehicle 4 that is near the own vehicle 2 and is capable of relaying the radar wave between the own vehicle 2 and the stationary object 6, from a plurality of target objects detected by the target object detecting unit 84.

Here, for example, the relay reflection target object selecting unit 87 may select all of the target objects detected by the target object detecting unit 84 in order from that nearest to the own vehicle 2. In this case, if the multipath ghost 8 generated by reflection of the radar wave is determined for each relay reflection target object, and the target object determined to be the multipath ghost 8 be eliminated from the relay reflection target objects, the multipath ghost 8 can be successively determined.

However, when the determination is performed in such a manner, in cases in which many target objects are detected by the target object detecting unit 84, the number of relay reflection target objects used to determine the multipath ghost 8 also increases, and time is required for the determination of the multipath ghost 8. Moreover, unnecessary determinations are performed.

Therefore, according to the present embodiment, in the relay reflection target object selecting unit 87, the number of target objects selected as the relay reflection target object is restricted by only the number of moving bodies set in advance that are near the own vehicle 2 and capable of relaying the radar wave between the own vehicle 2 and the stationary object 6 being selected.

Next, the multipath ghost condition setting unit 88 sets a multipath ghost condition based on the distance R, the azimuth θ, and the velocity V of the target object selected as the relay reflection target object by the relay reflection target object selecting unit 87 and the velocity of the own vehicle 2.

The multipath ghost condition prescribes a position and a velocity of the multipath ghost 8, that is, a distance Rg and an azimuth θg from the own vehicle 2 to the multipath ghost 8, and a multipath ghost velocity Vg that is a relative velocity between the own vehicle 2 and the multipath ghost 8.

Of the foregoing, the multipath ghost velocity Vg [m/s] is estimated based on a relay reflection target object velocity Vr [m/s] that is a relative velocity between the relay reflection target object and the own vehicle 2, an azimuth θr [deg] of the relay reflection target object, and a vehicle velocity Vs [m/s] that is the velocity of the own vehicle 2. For example, a following expression is used for the estimation.

$$Vg [ m / s ] = 2 \times Vr [ m / s ] + Vs [ m / s ] \times cos θ r [ deg ]$$

A reason for this is that the radar wave that is relayed by the relay reflection target object passes through the relay reflection target object twice, and the radar wave enters the own vehicle 2 at substantially the same angle as the azimuth θr [deg] of the relay reflection target object. Here, in the above-described arithmetic expression, the vehicle velocity Vs [m/s] of the own vehicle 2 is acquired through the input/output unit 90 from an external apparatus, such as the driving assistance ECU 100.

In addition, the multipath ghost condition is prescribed by three conditions 1 to 3, below, with the target object to be subjected to the determination of the multipath ghost 8 as a determination target object.

determination target object distance Rt[m]−relay reflection target object distance Rr[m]>distance difference thresholdΔR[m] Condition 1

|determination target object velocity Vt[m/s]−multipath ghost velocity Vg[m/s]|<velocity difference thresholdΔV[m/s] Condition 2

|determination target object azimuthθt[deg]−relay reflection target object azimuthθr[deg]|<azimuth difference threshold[deg] Condition 3

That is, Condition 1 indicates that the determination target object distance Rt [m] that is the distance from the own vehicle 2 to the determination target object is longer than the distance Rm [m] to the relay reflection target object by more than the difference threshold ΔR [m] set in advance.

In addition, Condition 2 indicates that the absolute value of the difference between the determination target object velocity Vt [m/s] that is the relative velocity between the own vehicle 2 and the determination target object, and the multipath ghost velocity Vg [m/s] calculated by the above-described arithmetic expression is less than the velocity difference threshold ΔV [m/s] set in advance. In other words, Condition 2 indicates that the determination target object velocity Vt [m/s] and the multipath ghost velocity Vg [m/s] are substantially the same.

Furthermore, Condition 3 indicates that the absolute value of the difference between the azimuth θt [deg] of the determination target object and the azimuth θr [deg] of the relay reflection target object is less than the azimuth difference threshold 40 [deg] set in advance. In other words, Condition 3 indicates that the determination target object azimuth θt [deg] and the relay reflection target object azimuth θr [deg] are substantially the same.

Next, the multipath ghost determining unit 89 extracts a target object that meets the multipath ghost condition set by the multipath ghost condition setting unit 88 from the plurality of target objects detected by the target object detecting unit 84, and determines the extracted target object to be the multipath ghost 8.

In addition, the multipath ghost determining unit 89 restricts output of the detection result from the target object information output unit 86 to the driving assistance ECU 100 regarding the target object that is determined to be the multipath ghost 8.

Here, according to the present embodiment, for the target object that is determined to be the multipath ghost 8, the multipath ghost determining unit 89 adds information indicating that the target object is the multipath ghost 8 to the target object information and outputs the target object information to the driving assistance ECU 100 from the target object information output unit 86. As a result, the driving assistance ECU 100 can be notified that the multipath ghost 8 is easily generated in an area in which the own vehicle 2 is currently traveling. The driving assistance ECU 100 can make a higher-order server connected through wireless communication or the like learn the area in which the multipath ghost 8 is easily generated.

### [Multipath Ghost Determination Process]

Next, a multipath ghost determination process that is performed by the CPU 71 of the processing unit 70 to actualize functions as the relay reflection target object selecting unit 87, the multipath ghost condition setting unit 88, and the multipath ghost determining unit 89 will be described.

The multipath ghost determination process is a process that is performed synchronously with the target object detection process that is periodically performed by the CPU 71 to actualize functions as the frequency analysis unit 82 and the target detecting unit 84. The multipath ghost determination process is performed by the CPU 71 running a program stored in the memory 72.

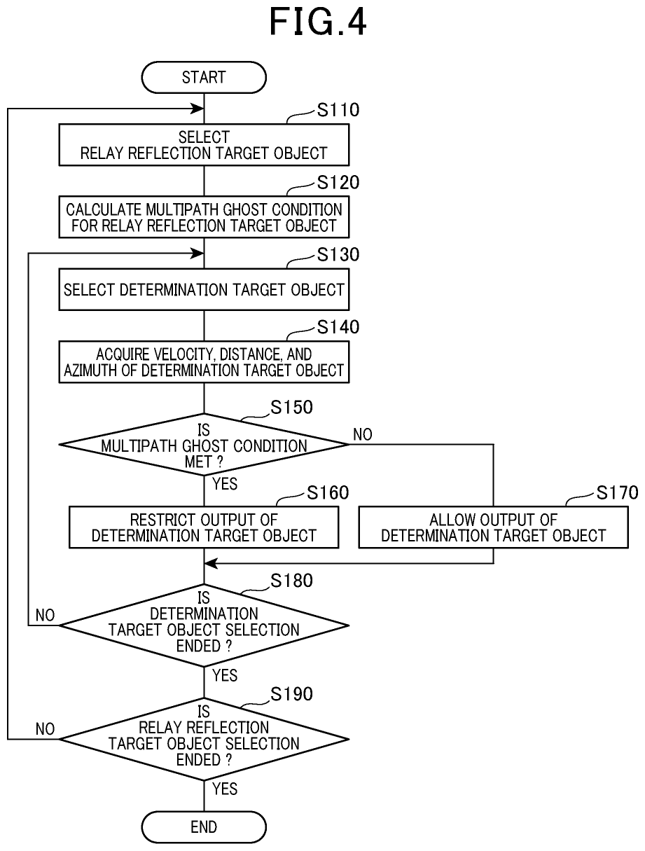

As shown in FIG. 4, in the multipath ghost determination process, first, at S110, a process as the relay reflection target object selecting unit 87 that selects the relay reflection target object from the plurality of target objects detected in the target object detection process is performed. The CPU 71 proceeds to S120.

At S120, the vehicle velocity Vs of the own vehicle 2 is acquired from the driving assistance ECU 100 through the input/output unit 90. Then, a process as the multipath ghost condition setting unit 88 that calculates the above-described multipath ghost condition based on the acquired vehicle velocity Vs, and the distance R, the azimuth θ, and the velocity V of the target object selected as the relay reflection target object at S110 is performed.

Next, at S130, the target object of which the distance between the target object and the own vehicle 2 is longer than that of the relay reflection target object is selected as the determination target object from the plurality of target objects detected by the target object detecting unit 84. The CPU 71 proceeds to S140.

Nere, the selection of the determination target object is performed in order from the target object nearest to the own vehicle 2. In addition, as a selection condition for the determination target object, selection of a target object within a predetermined angular range with the azimuth of the relay reflection target object as the center may be set, in addition to the distance between the target object and the own vehicle 2.

At S140, the distance R, the azimuth θ, and the velocity V of the target object selected as the determination target object at S130 are respectively acquired as the above-described determination target object distance Rt, the determination target object azimuth θt, and the determination target object velocity Vt.

Then, at subsequent S150, whether the determination target object distance Rt, the determination target object azimuth θt, and the determination target object velocity Vt acquired at S140 respectively meet the above-described Condition 1 to Condition 3 is determined.

At S150, when the determination target object distance Rt, the determination target object azimuth θt, and the determination target object velocity Vt all meet the above-described Condition 1 to Condition 3, the multipath ghost condition is determined to be met. The CPU 71 proceeds to S160.

Then, at S160, because the multipath ghost condition is met, the determination target object is determined to be the multipath ghost 8. Output of the target object information on the determination target object from the target object information output unit 86 is restricted. The CPU 71 proceeds to S180.

Here, the output restriction at S160 may be such that output of the target object information is restricted. However, as described above, according to the present embodiment, information that the target object is a multipath ghost 8 is added to the target object information on the determination target object and the target object information is outputted from the target object information output unit 86.

Meanwhile, at S150, when the multipath ghost condition is determined to not be met, the determination target object is a target object that is actually present. Therefore, the CPU 71 proceeds to S170. Output of the target object information on the determination target object is allowed. The CPU 71 proceeds to S180.

At S180, whether the selection of the determination target object is ended is determined by determination of whether all target objects meeting the selection condition have been selected as the determination target object at S130. Then, when the selection of the determination target object is determined to have ended at S180, the CPU 71 proceeds to S190. When the selection of the determination target object is determined to have not ended at S180, the CPU 71 proceeds to S130 and performs the processes at S130 and subsequent steps again.

Next, at S190, whether the selection of the relay reflection target object is ended is determined by determination of whether a predetermined number of relay reflection target objects have been selected at S110. Then, when the selection of the relay reflection target object is determined to have ended at S190, the multipath ghost determination process is ended. When the selection of the relay reflection target object is determined to have not ended at S190, the CPU 71 proceeds to S110 and performs the processes at S110 and subsequent steps again.

Here, the processes at S130 to S190 function as the multipath ghost determining unit 89.

### Effects

As described above, in the radar apparatus 10 according to the present embodiment, the relay reflection target object is selected from a plurality of target objects that are detected by the transmission and reception of radar waves. The multipath ghost condition is set based on the position and the velocity of the relay reflection target object and the velocity of the own vehicle.

Then, the target object that meets the multipath ghost condition is extracted from the plurality of detected target objects. The extracted target object is determined to be the multipath ghost 8. Output of the detection result of this target object to an external apparatus is restricted.

Therefore, as a result of the radar apparatus 10 according to the present embodiment, whether the detected target object is the multipath ghost 8 can be determined without a reflection point that causes the multipath ghost 8 being identified, and a relative velocity between the reflection point and the own vehicle being detected as described in JP 2020-197506 A.

Therefore, as a result of the radar apparatus 10 according to the present embodiment, the determination of the multipath ghost 8 can be performed by a simpler determination operation than that of the apparatus described in JP 2020-197506 A. Consequently, the determination of the multipath ghost 8 can be appropriately performed even during high-speed travel of the own vehicle 2 and the like in which the determination of the multipath ghost 8 is required to be performed in a short amount of time.

In addition, when the detected target object is the multipath ghost 8, because output of the detection result of the target object to the driving assistance ECU 100 is restricted, the driving assistance ECU 100 can be suppressed from erroneously operating as a result of the multipath ghost 8 that is not actually present. For example, the driving assistance ECU 10 can be suppressed from erroneously controlling the own vehicle 2 to avoid the multipath ghost 8 that is not actually present.

Furthermore, in the vehicle radar apparatus of the present disclosure, the multipath ghost condition is set under an assumption that a reflection object that causes the multipath ghost 8 is the stationary object 6, such as a guardrail. Therefore, decrease in detection accuracy of a moving body that is required for traveling assistance of the own vehicle 2 can be suppressed without the detected target object being erroneously determined to be the multipath ghost 8 generated by the moving body. The driving assistance ECU 100 can be made to favorably perform traveling assistance for the own vehicle 2.

### OTHER EMBODIMENTS

An embodiment of the present disclosure is described above. However, the present disclosure is not limited to the above-described embodiment. Various modifications are possible.

For example, according to the above-described embodiment, in the multipath ghost determination process in FIG. 4, when the multipath ghost condition is determined to be met at S150, the determination target object is determined to be the multipath ghost 8. The CPU 71 proceeds to S160, and output of the target object information is restricted.

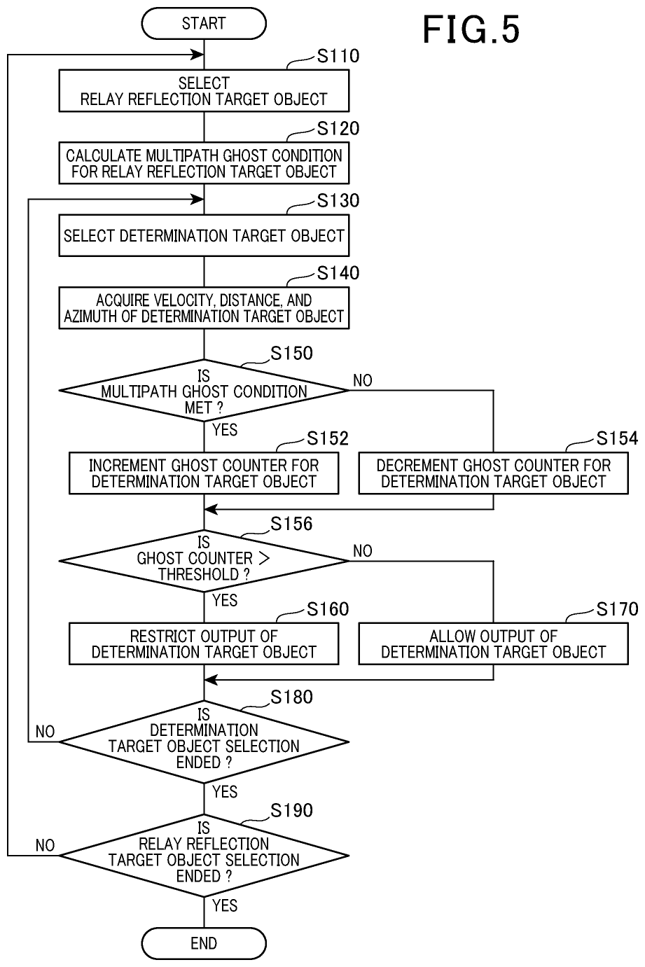

However, when the multipath ghost condition is merely met once, the determination target object being erroneously determined to be the multipath ghost 8 can be considered. Therefore, the multipath ghost determination process may be performed by steps shown in FIG. 5.

That is, in the multipath ghost determination process shown in FIG. 5, when the multipath ghost condition is determined to be met at S150, at S152, a ghost counter for the determination target object that is currently selected is incremented. The CPU 71 proceeds to S156.

In addition, when the multipath ghost condition is determined to not be met at S150, at S154, the ghost counter for the determination target object that is currently selected is decremented. The CPU 71 proceeds to S156. Here, when a minimum value of the ghost counter is zero and the multipath ghost condition is not met, the ghost counter is not updated to a negative value as a result of the ghost counter being decremented.

In addition, at S156, whether the value of the ghost counter exceeds a threshold set in advance is determined. When the value of the ghost counter exceeds the threshold, the determination target object is determined to be the multipath ghost 8. The CPU 71 proceeds to S160. Otherwise, the CPU 71 proceeds to S170.

As a result of the multipath ghost determination process being performed in this manner, each time the target object detected in the target object detection process that is periodically repeatedly performed is extracted as the multipath ghost 8, the ghost counter for the target object is counted upward. Then, when the target object is extracted as the multipath ghost 8 a plurality of times, the ghost counter reaches a threshold and the target object is determined to be the multipath ghost 8.

Therefore, at S156, the determined target object being the multipath ghost 8 can be more accurately determined. Determination accuracy regarding the multipath ghost 8 can be improved.

Next, a method for the multipath ghost determination by the processing unit 70 may be implemented by a dedicated computer that is provided so as to be configured by a processor and a memory, the processor being programmed to provide one or a plurality of functions that are realized by a computer program. Alternatively, the method for the multipath ghost determination by the processing unit 70 may be implemented by a dedicated computer that is provided by a processor being configured by a single dedicated hardware logic circuit or more. Still alternatively, the method for the multipath ghost determination by the processing unit 70 may be implemented by a single dedicated computer or more. The dedicated computer may be configured by a combination of a processor that is programmed to provide one or a plurality of functions, a memory, and a processor that is configured by a single hardware logic circuit or more. In addition, the computer program may be stored in a non-transitory computer-readable (tangible) storage medium that can be read by a computer as instructions performed by the computer.

In addition, the computer program run in the processing unit 70 may be stored in a non-transitory computer-readable (tangible) storage medium that can be read by a computer as instructions performed by the computer. A method for actualizing functions of sections included in the processing unit 70 is not necessarily required to include software. All of the functions may be implemented through use of a single or a plurality of pieces of hardware.

A plurality of functions provided by a single constituent element according to the above-described embodiments may be implemented by a plurality of constituent elements. A single function provided by a single constituent element may be implemented by a plurality of constituent elements. In addition, a plurality of functions provided by a plurality of constituent elements may be implemented by a single constituent element. A single function provided by a plurality of constituent elements may be implemented by a single constituent element. Furthermore, a part of a configuration according to the above-described embodiment may be omitted. Moreover, at least a part of a configuration according to an above-described embodiment may be added to or replace a configuration according to another of the above-described embodiments.

The present disclosure can also be implemented by various modes in addition to the above-described vehicle radar apparatus, such as a system in which the vehicle radar apparatus is a constituent element, a program for enabling a computer to function as the vehicle radar apparatus, a non-transitory computer-readable (tangible) storage medium such as a semiconductor memory that stores the program therein, and a multipath ghost determination method of the vehicle radar apparatus.

What is claimed is:

1. A vehicle radar apparatus that is mounted to a vehicle and detects a target object in a vicinity of an own vehicle, the vehicle radar apparatus comprising:
a target object detecting unit that is configured to detect a position and a velocity of the target object by transmitting a radar wave to the vicinity of the own vehicle, receiving a reflected wave of the radar wave, and performing frequency analysis on transmission and reception signals;
a relay reflection target object selecting unit that is configured to select, as a relay reflection target object, a moving body that is capable of relaying transmission and reception of the radar wave to and from another target object, from a plurality of target objects detected by the target object detecting unit;
a multipath ghost condition setting unit that is configured to set a multipath ghost condition that indicates the position and the velocity of the target object erroneously detected by the target object detecting unit as a result of a stationary object to which the radar wave is relayed by the relay reflection target object, based on the position and the velocity of the relay reflection target object and a velocity of the own vehicle; and
a multipath ghost determining unit that is configured to extract a target object that meets the multipath ghost condition from the plurality of target objects detected by the target object detecting unit, determine that the extracted target object is a multipath ghost, and restrict output of a detection result from the target object detecting unit to an external apparatus.

2. The vehicle radar apparatus according to claim 1, wherein:
the target object detecting unit is configured to periodically repeatedly perform a detection operation of the target object; and
in response to the target object that meets the multipath ghost condition being extracted a plurality of times from the plurality of target objects detected by the target object detecting unit, the multipath ghost determining unit is configured to determine that the target object that is extracted a plurality of times is the multipath ghost.

3. The vehicle radar apparatus according to claim 1, wherein:
the multipath ghost condition setting unit is configured to estimate a velocity of the multipath ghost based on the azimuth and the velocity of the relay reflection target object and the velocity of the own vehicle, and set the multipath ghost condition based on the estimated multipath ghost velocity, and an azimuth and a distance of the relay reflection target object.

4. The vehicle radar apparatus according to claim 2, wherein:
the multipath ghost condition setting unit is configured to estimate a velocity of the multipath ghost based on the azimuth and the velocity of the relay reflection target object and the velocity of the own vehicle, and set the multipath ghost condition based on the estimated multipath ghost velocity, and an azimuth and a distance of the relay reflection target object.

5. The vehicle radar apparatus according to claim 1, wherein:
the multipath ghost determining unit is configured to attach information indicating that the target object is the multipath ghost to the target object that is determined to be the multipath ghost among the plurality of target objects detected by the target object detecting unit, and output the detection result of the target object from the target object detecting unit to the external apparatus.

6. The vehicle radar apparatus according to claim 2, wherein:
the multipath ghost determining unit is configured to attach information indicating that the target object is the multipath ghost to the target object that is determined to be the multipath ghost among the plurality of target objects detected by the target object detecting unit, and output the detection result of the target object from the target object detecting unit to the external apparatus.

7. The vehicle radar apparatus according to claim 3, wherein:
the multipath ghost determining unit is configured to attach information indicating that the target object is the multipath ghost to the target object that is determined to be the multipath ghost among the plurality of target objects detected by the target object detecting unit, and output the detection result of the target object from the target object detecting unit to the external apparatus.

8. The vehicle radar apparatus according to claim 4, wherein:
the multipath ghost determining unit is configured to attach information indicating that the target object is the multipath ghost to the target object that is determined to be the multipath ghost among the plurality of target objects detected by the target object detecting unit, and output the detection result of the target object from the target object detecting unit to the external apparatus.

9. A vehicle radar apparatus that is mounted to a vehicle and detects a target object in a vicinity of an own vehicle, the vehicle radar apparatus comprising:
a processor;
a non-transitory computer-readable storage medium; and
a set of computer-executable instructions stored in the computer-readable storage medium that, when read and executed by the processor, to implement:
detecting a position and a velocity of the target object by transmitting a radar wave to the vicinity of the own vehicle, receiving a reflected wave of the radar wave, and performing frequency analysis on transmission and reception signals;
selecting, as a relay reflection target object, a moving body that is capable of relaying transmission and reception of the radar wave to and from another target object, from a plurality of target objects detected;
setting a multipath ghost condition that indicates the position and the velocity of the target object erroneously detected as a result of a stationary object to which the radar wave is relayed by the relay reflection target object, based on the position and the velocity of the relay reflection target object and a velocity of the own vehicle; and
extracting a target object that meets the multipath ghost condition from the plurality of target objects detected, determine that the extracted target object is a multipath ghost, and restrict output of a detection result from the target object detecting unit to an external apparatus.
